(19) United States
(12) Patent Application Publication
(10) Pub. No.: US 2020/0336620 A1
(43) Pub. Date: Oct. 22, 2020

(54) IMAGE PROCESSING APPARATUS AND RECORDING MEDIUM

(71) Applicant: Konica Minolta, Inc., Tokyo (JP)

(72) Inventor: Hiroaki KUBO, Muko-shi (JP)

(73) Assignee: Konica Minolta, Inc., Tokyo (JP)

(21) Appl. No.: 16/839,251

(22) Filed: Apr. 3, 2020

(30) Foreign Application Priority Data
Apr. 22, 2019 (JP) 2019-80902

(51) Int. Cl. H04N 1/40; H04N 1/00

(52) U.S. Cl. CPC H04N 1/40068; H04N 1/00005

(57) ABSTRACT

An image processing apparatus including a processor that performs: compressing target data for printing; decompressing the compressed target data; and when the resolution of the uncompressed target data is higher than the resolution of low-resolution data included in the compressed target data, generating sample data by decompressing only the low-resolution data, the sample data to be used for a process of detecting data of a particular image from the target data.

The disclosure of Japanese Patent Application No. 2019-080902 filed on Apr. 22, 2019, including description, claims, drawings, and abstract, is incorporated herein by reference in its entirety.

### BACKGROUND

### Technological Field

The present invention relates to: an image processing apparatus that is capable of detecting data of a particular image such as a paper currency or money image from target data for printing; and a recording medium.

### Description of the Related Art

Image processing apparatuses that are capable of detecting data of a particular image from target data for printing have been introduced for the purpose of preventing the forgery of paper currency or money.

Image processing apparatuses detect data of a particular image from target data for printing, by detecting a predetermined image that is an image having a particular shape, for example. An algorithm that overcomes low resolution due to a poor-quality picture is embedded in the mechanism of detecting a particular image; accordingly, sample data for the detection process is not necessarily high-resolution.

Image processing apparatuses perform the detection process conventionally right before binarization, a preparatory process for printing. This means they are capable of detecting a particular image even after image editing, size reduction, or enlargement.

With the advance of high-resolution image processing techniques, image processing apparatuses are becoming required to process huge amounts of data. To lighten the burden due to high-resolution data, image processing apparatuses compress data and store it on a memory for later use; then, when a need for image editing arises, they decompress the compressed data. Similarly, they keep target data for printing as compressed data until a need for printing arises. Specifically, before binarization as a preparatory process for printing, they perform: decompressing the compressed data to the original form; and detecting a particular image from the target data.

It should be noted again that, sample data for the process of detecting a particular image from target data for printing is not necessarily high-resolution. So, they generate sample data for the detection process by downgrading the resolution of the decompressed data. Meanwhile, the burden due to the process of generating sample data grows depending on the resolution of original target data, which is a problem to be solved.

Japanese Unexamined Patent Application Publication No. 2010-124069 introduces an image processing apparatus having: a function of prohibiting data of an illegal image from being printed when there are images that are different in image quality and the illegal image is recognized as a particular image; and a function of preventing the other images from being recognized by error as a particular image. The image processing apparatus is provided with: a particular pattern detecting portion that detects, from image data, a graphical pattern that is similar to a prohibited pattern; and a similarity judgment portion that judges the degree of similarity of the detected graphical image to the prohibited pattern. The particular image detecting portion has a judgment portion that judges whether or not the image data, including the detected graphical pattern, is data of the particular image, including the prohibited pattern, by comparing the degree of similarity to a predetermined threshold. The predetermined threshold is a first threshold when an image quality of the image data, indicated by the image quality determination information, is higher than a reference value; and the predetermined threshold is a second threshold that is greater than the first threshold, when the image quality of the image data is equal to or lower than the reference value.

Japanese Unexamined Patent Application Publication No. 2001-218044 introduces an image input-output device that is capable of quickly detecting a particular image from a document, for the purpose of preventing the forgery of paper currency or the like. The image input-output device stores a scanned image on a storage device and reads it out band by band. A resolution downgrade circuit performs resolution downgrade by reducing the number of pixels in each band and inputs the low-resolution image to a detection circuit. The detection circuit then detects a particular image from the inputted image by detecting a digital watermark or by image matching. When detection fails, the detection circuit again performs detection using the original scanned image.

Japanese Unexamined Patent Application Publication No. 2001-094774 introduces an image reading device that is capable of effectively preventing forgery. Optical scanning machinery reads a document, corrects the scanned image data in a predetermined manner, and transfers it to a compressor-decompressor and a scanner gamma converter. The scanner gamma converter performs gamma conversion on the image data and transfers it to a particular image detector. The particular image detector performs the process of detecting a particular image from the image data, by well-known pattern recognition and matching techniques. While the particular image detector performs the detection process, a CPU stores the image data on a memory. Depending on the success or failure of detection, the CPU judges whether or not the image data should be outputted from the memory and decompressed. Upon the success of detection, an output controller prohibits the output of the image data from the memory.

The techniques disclosed in Japanese Unexamined Patent Application Publications No. 2010-124069, 2001-218044, and 2001-094774, however, do not relate to the problem that the burden due to the process of generating, from original target data for printing, sample data to be used for the process of detecting a particular image such as a paper currency image grows depending on the resolution of the original target data; none of these techniques can bring an effective solution to the problem.

The present invention, which has been made in consideration of such a technical background as described above, is capable of lightening the burden due to the process of generating, from original target data for printing, sample data to be used for the process of detecting a particular image such as a paper currency or money image.

### SUMMARY

The present invention, which has been made in consideration of such a technical background as described above, is capable of lightening the burden due to the process of generating, from original target data for printing, sample data to be used for the process of detecting a particular image such as a paper currency or money image.

A first aspect of the present invention relates to an image processing apparatus comprising a processor that performs:

compressing target data for printing;

decompressing the compressed target data; and

when the resolution of the uncompressed target data is higher than the resolution of low-resolution data included in the compressed target data, generating sample data by decompressing only the low-resolution data, the sample data to be used for a process of detecting data of a particular image from the target data.

A second aspect of the present invention relates to a non-transitory computer-readable recording medium storing a program for a computer of an image processing apparatus to execute:

compressing target data for printing;

decompressing the compressed target data; and

when the resolution of the uncompressed target data is higher than the resolution of low-resolution data included in the compressed target data, generating sample data by decompressing only the low-resolution data, the sample data to be used for a process of detecting data of a particular image from the target data.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating a configuration of an image processing apparatus according to one embodiment of the present invention.

FIG. 2 is a flowchart representing a procedure to be performed on print data during a print job.

FIG. 3 is for reference in describing in detail how print data is processed during a print job.

FIG. 4 is a flowchart representing a procedure to be performed on print data during a print job by the image processing apparatus in the embodiment of FIGS. 2 and 3.

FIG. 5 is a flowchart representing a procedure to be performed on print data during a print job, according to another embodiment of the present invention.

FIG. 6 is for reference in describing in detail how print data is processed during a print job in the embodiment of FIG. 5.

FIG. 7 is a flowchart representing a procedure to be performed on print data during a print job by the image processing apparatus in the embodiment of FIGS. 5 and 6.

FIG. 8 is a flowchart representing a procedure to be performed on scanned data, according to yet another embodiment of the present invention.

FIG. 9 is a flowchart representing a conventional procedure to be performed on print data during a print job, and this figure corresponds to FIG. 2.

FIG. 10 is for reference in describing in detail how print data is conventionally processed during a print job in the embodiment of FIG. 9, and this figure corresponds to FIG. 3.

FIG. 11 is a flowchart representing a conventional procedure to be performed on print data during a print job by the image processing apparatus in the embodiment of FIGS. 9 and 10, and this figure corresponds to FIG. 4.

FIG. 12 is a flowchart representing a conventional procedure to be performed on scanned data.

### DETAILED DESCRIPTION OF EMBODIMENTS

Hereinafter, one or more embodiments of the present invention will be described with reference to the drawings. However, the scope of the invention is not limited to the disclosed embodiments.

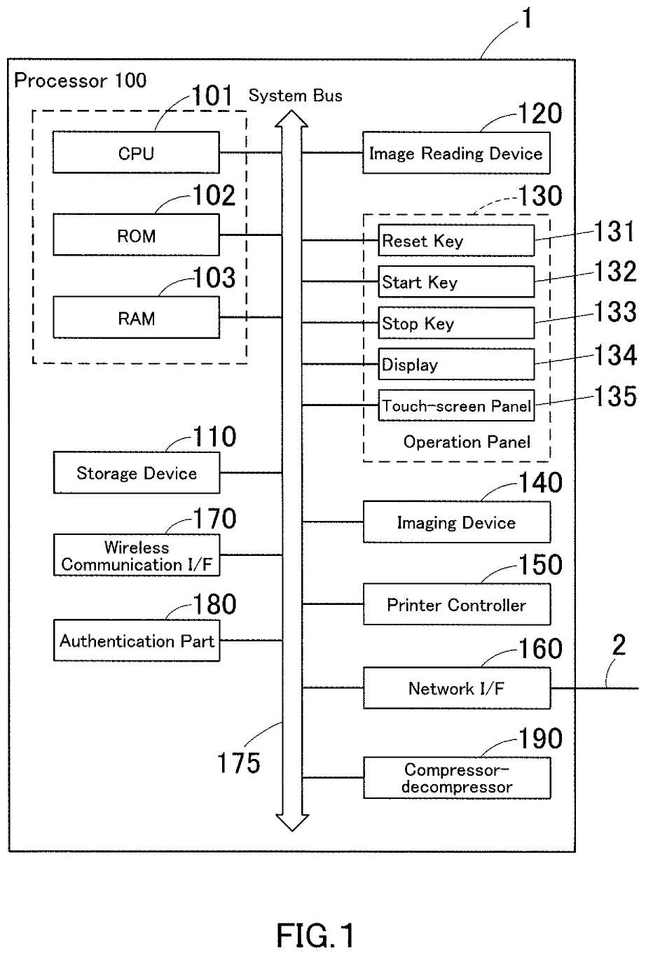

FIG. 1 is a block diagram illustrating a configuration of an image processing apparatus 1 according to one embodiment of the present invention. In this embodiment, a multi-function peripheral (MFP) i.e. a multifunctional machine having various functions such as a copier function, a printer function, a scanner function, and a facsimile function is employed as the image processing apparatus 1.

As illustrated in FIG. 1, the image processing apparatus 1 is essentially provided with a processor 100, a storage device 110, an image reading device 120, an operation panel 130, an imaging device 140, a printer controller 150, a network interface (network I/F) 160, a wireless communication interface (wireless communication I/F) 170, an authentication part 180, and a compressor-decompressor 190, all of which are connected to each other through a system bus 175.

The processor 100 is essentially provided with a central processing unit (CPU) 101, a read-only memory (ROM) 102, and a random-access memory (RAM) 103.

The CPU 101 controls the MFP 1 in a unified and systematic manner by executing the programs stored on a recording medium such as the ROM 102. For example, the CPU 101 controls the MFP 1 in such a manner that allows its copier, printer, scanner, and facsimile function to run properly. Furthermore, in this embodiment, the CPU 101 essentially performs the following processes: compressing and decompressing target data for printing by the compressor-decompressor 190; performing the process of detecting a particular image such as a paper currency or money image; generating sample data for the detection process from the target data; and performing raster image processing if the target data is received externally. These processes will be later described in detail.

The ROM 102 stores programs for the CPU 101 to execute and other data.

The RAM 103 serves as a workspace for the CPU 101 to load programs, and it temporarily stores programs, data for executing the programs, and other data.

The storage device 110 is comprised of a hard disk drive, for example, and it stores programs and data of various types such as target data for printing.

The image reading device 120 is essentially provided with a scanner, and it obtains an image by scanning a document put on a platen and converts the obtained image into an image data format.

The operation panel 130 allows the user to give instructions such as jobs to the MFP 1 and to configure various settings of the MFP 1. The operation panel 130 is essentially provided with a reset key 131, a start key 132, a stop key 133, a display 134, and a touch-screen panel 135.

The reset key 131 allows the user to reset the settings. The start key 132 allows the user to start an operation, for example, scanning. The stop key 133 allows the user to stop an operation.

The display 134 is comprised of a liquid-crystal display device, for example, and it displays messages, various operation screens, and the like. The touch-screen panel 135 is disposed on the display screen of the display 134, and it detects touch events.

The imaging device 140 makes physical prints from image data obtained from a document by the image reading device 120, image data stored on the storage device 110, and a copy image created from print data externally received.

The printer controller 150 creates a copy image from print data received by the network interface 160.

The network I/F 160 serves as a transceiver that exchanges data with external apparatuses through a network 2. The wireless communication I/F 170 is an interface that communicates with external apparatuses using near-field wireless communication technology.

The authentication part 180 obtains identification information of a user who intends to logon, and performs authentication by comparing the identification information to proof information stored on a recording medium such as the fixed storage device 110.

The compressor-decompressor 190 compresses target data for printing e.g. print data and decompresses compressed data.

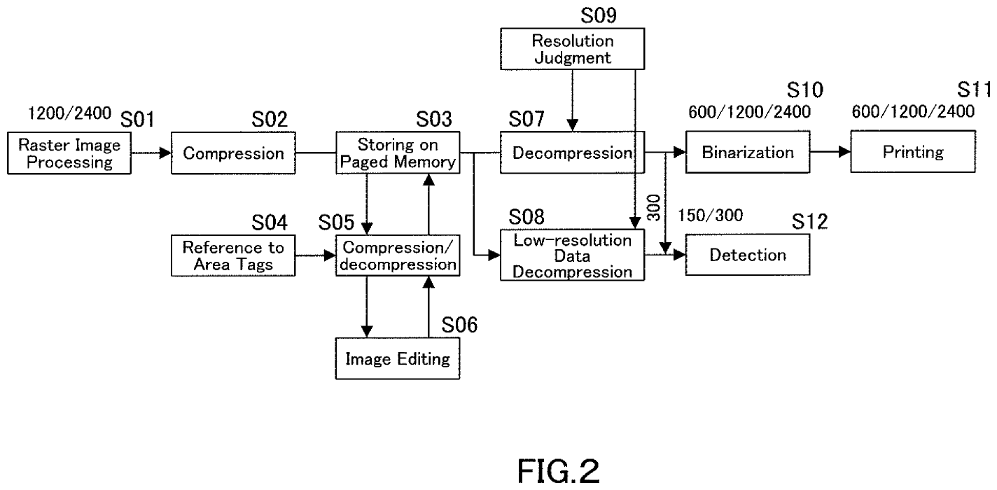

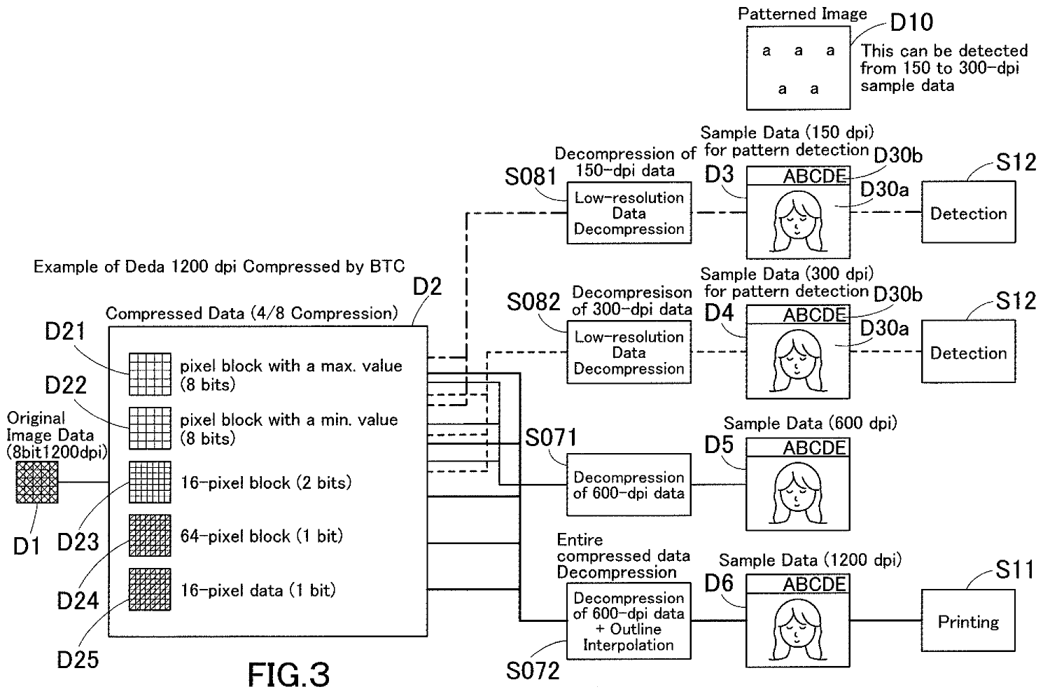

As described above, the image processing apparatus 1 has a function of detecting a particular image such as a paper currency or money image from sample data generated from the target data. Sample data generation will be described with reference to FIGS. 2 and 3. In the embodiment below, target data for printing is print data received from a user terminal or another external apparatus.

FIG. 2 is a flowchart representing a procedure to be performed on print data during a print job, including the process of generating sample data and the detection process.

Receiving print data through the network 2, the image processing apparatus 1 performs raster image processing on the print data (S01); text and image data is thus converted into a raster graphics format. Here, raster image processing is not explained in detail since it is a publicly-known technique. During raster image processing, area tags, which define a graphics area, are generated; in the embodiment of FIGS. 2 and 3, however, sample data generation is performed without area tags.

The print data in a raster graphics format is compressed by the compressor-decompressor 190 (S02); the compressed data is stored on the RAM (paged memory) 103 (S03).

When a need for image editing arises, the compressed data stored on the paged memory 103 is decompressed (S05). After image editing (S06), it is compressed again (S05) and stored on the paged memory 103. Meanwhile, the edited print data is stored on a recording medium such as the storage device 110 as well.

The compressor-decompressor 190 performs compression and decompression (S05) with reference to area tags (TAG) (S04). As described above, area tags are generated during raster image processing. In raster image processing, copy data obtained by document scanning is converted to pixel positions, pixel size, and specified brightness so that an image can be plotted by pixels accordingly. Furthermore, in raster image processing, points and lines composing text and Bezier curves composing graphics are converted to values so that images can be plotted by calculation. As described above, area tags that define a graphics area, in other words, area tags that indicate the boundary between a graphics area and a non-graphics area are generated because graphics data and non-graphics data are converted into a raster graphics format in different methods. With reference to the area tags, the graphics area and the non-graphics area are compressed and decompressed accordingly.

When a need for printing arises, the compressed data stored on the paged memory 103 is decompressed (S07). After that, it is converted into binary form (S10) and printed (S11).

Meanwhile, the resolutions of pieces of data composing the compressed data stored on the paged memory 103 are judged (S09). Only low-resolution pieces of data are decompressed and sample data is thereby obtained (S08). Using the sample data thus obtained, particular image detection is performed (S12).

FIG. 3 is for reference in describing in detail how print data is processed during a print job. In the embodiment of FIG. 3, original print data D1 is 8-bit data with a resolution of 1200 dpi (dots per inch). Similar to sample image data D3 and D4 in the right half of FIG. 3, the original print data D1 has graphics in the lower region D30a and a color chart (for example, a yellow gradient chart) in the upper region D30b. The color chart has the text “ABCDE” in black and is created by computer graphics (CG) techniques. In this embodiment, image compression is performed by block truncation coding (BTC), for example. In BTC compression, original image data is divided into multiple blocks and pixel values in each block are used; a pixel value represents the gray level of a pixel and it is an integer ranging from 0 to 255.

The original print data D1 (32×32 pixels), whose resolution is 1200 dpi, is compressed, resulting in compressed data D2 which is composed of five pieces of data D21 to D25. The data D21 is 8-bit data; the data D22 is 8-bit data; the data D23 is 2-bit data; the data D24 is 1-bit data; and the data D25 is 1-bit data.

The data D21 is 8×8 pixel blocks each with a maximum value (150 dpi, approximately); the data D22 is 8×8 pixel blocks each with a minimum value (150 dpi, approximately); and the data D23 is 16-pixel blocks, each consisting of 2×2 pixel blocks each with a mean value (600 dpi, approximately). The data D24 is 64-pixel blocks each with the number of black and white pixels after the values are converted into binary form; the data D25 is 16-pixel blocks each with a degree of pixel modulation. A combination of pieces of data changes depending on the degree of pixel modulation. High frequencies bring along more detail and an additional amount of data; these pieces of data are given short bit-lengths for data size reduction.

These pieces of data are used for decompression. The data D23, which is derived from the smallest pixel blocks, is used as the following: the outline is interpolated using the number of edge pixels and their neighboring patterns such that high frequencies are represented by pixel values that rapidly change in space.

The sample image data D3 to D6 in the right half of FIG. 3 are decompressed data. The resolutions of the sample image data D3 to D6 are actually different, however, it is not easy to put the condition into the form of illustration. Those illustrated herein are thus exactly alike only for the sake of convenience.

When a need for printing arises, decompression is performed using all the data D21 to D25 composing the compressed data D2 (decompression at 600 dpi and outline interpolation) (S072), and the sample image data D6, whose resolution is 1200 dpi just like the original image data is thereby obtained. After that, a preparatory process (binarization) is performed (S11). After the preparatory process, it is transferred to the imaging device 140 and printed out thereby. To obtain the sample image data D5, whose resolution is 600 dpi, decompression is performed using the data D21, D22, and D23 (S071).

Meanwhile, the process of detecting a particular image such as a paper currency or money image is performed using low-resolution data that can hardly reflect noise and a poor-quality picture. For example, the process of detecting a predetermined image D10 with a particular pattern is performed. The text “ABCDE” in the upper region D30b can be detected from sample image data with a resolution of 150 or 300 dpi; the predetermined image D11 having a particular pattern can be detected from such low-resolution data as well.

In this embodiment, the sample image data D3, whose resolution is 150 dpi, and the sample image data D4, whose resolution is 300 dpi, are generated from the compressed data D2. Specifically, as indicated by chain lines in FIG. 3, while the compressed data D2 is composed of the five pieces of data D21 to D25, the data D21 and D22 are used for generation of the sample image data D3. The data D21 (150 dpi, approximately) and the data D22 (150 dpi, approximately) have resolutions much lower than 1200 dpi, the resolution of the original print data D1. Low-resolution data decompression is performed (S081); in this process, the mean of the data D21 and D22 (150 dpi, approximately) is used. The sample image data D3, whose resolution of 150 dpi, is thereby obtained. The detection process is then performed using the sample image data D3 (S12).

Furthermore, as indicated by dashed lines in FIG. 3, the data D21, D22, and D23 are used for generation of the sample image data D4, whose resolution is 300 dpi. The data D21 (150 dpi, approximately), the data D22 (150 dpi, approximately), and the data D23 (600 dpi, approximately) have resolutions much lower than 1200 dpi, the resolution of the original print data D1. Low-resolution data decompression is performed (S082); in this process, the data D23 complements the data D21 and D22. The sample image data D4, whose resolution is 300 dpi, is thereby obtained. The detection process is then performed using the sample image data D4 (S12).

In FIG. 3, the resolution of the obtained sample data is 150 or 300 dpi, for example; the resolution of sample data is predetermined flexibly depending on the algorithm used in the detection process.

BTC compression and decompression are described above. Low-resolution data decompression may be performed by discrete cosine transformation (DCT) techniques, instead of BTC techniques, and sample data may be similarly generated thereby.

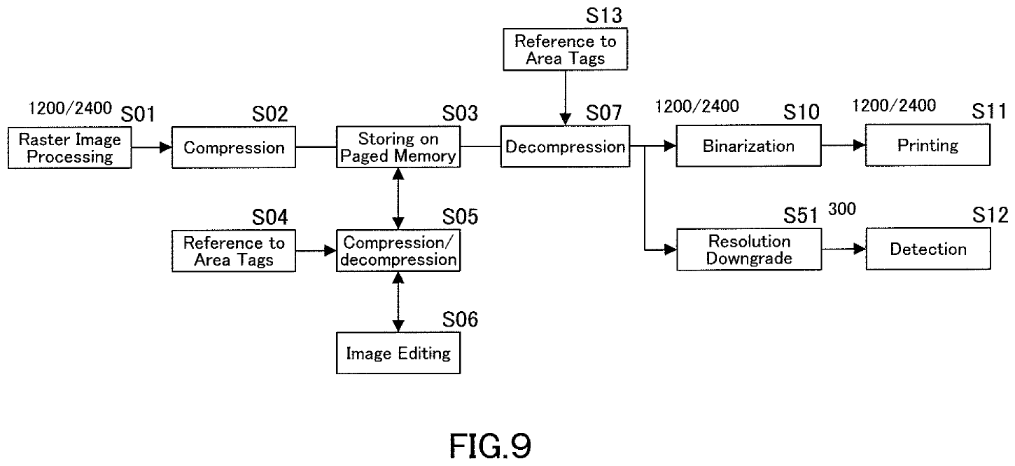

For reference, a conventional procedure to be performed on print data during a print job will be described with reference to FIG. 9. As referred to FIG. 9, the compressed data stored on the paged memory 103 is entirely decompressed (S07), and the original image data is thus retrieved. While binarization as a preparatory process for printing is in process (S10), resolution downgrade is performed on the decompressed data (S51), and sample data with a predetermined resolution is thereby obtained. The detection process is then performed using the sample data (S12). FIG. 9 includes some processes in common with FIG. 2, and these processes are given the same codes as in FIG. 2.

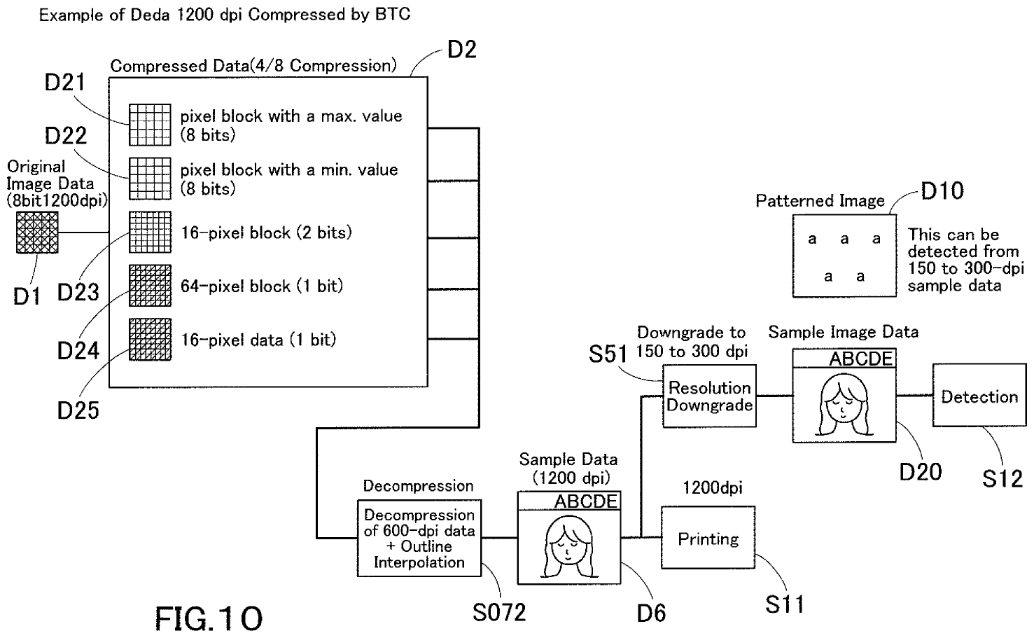

FIG. 10 is for reference in describing in detail how print data is conventionally processed during a print job in the embodiment of FIG. 9. As referred to FIG. 10, decompression is performed using all the data D21 to D25 composing the compressed data D2 (600 dpi data decompression and outline interpolation) (S072), and data with a resolution of 1200 dpi just like the original image data D1 is thereby obtained. While a preparatory process (binarization) is in process (S11), resolution downgrade is performed (S51) and the sample image data D20, whose resolution is 150 to 300 dpi, is thereby obtained. The burden due to resolution downgrade (S51) grows depending on the resolution of the original print data D1, which is a problem to be solved. FIG. 9 includes some processes in common with FIG. 2, and these processes are given the same codes as in FIG. 2.

Furthermore, in this embodiment, the resolution of target data for printing (original image data) (1200 dpi in the embodiment of FIG. 3) is much higher than the resolution of the data D21 and D22 (150 dpi in the embodiment of FIG. 3). The data D21 and D22 are low-resolution data included in the compressed data D2. Only the low-resolution data is decompressed, and the sample image data D3 and D4 to be used for the process of detecting a particular image is thereby obtained. This means, it is not necessary any more to decompress the compressed data D2 entirely or downgrade the resolution of the decompressed data. This would lighten the burden due to the process of generating sample data for the detection process.

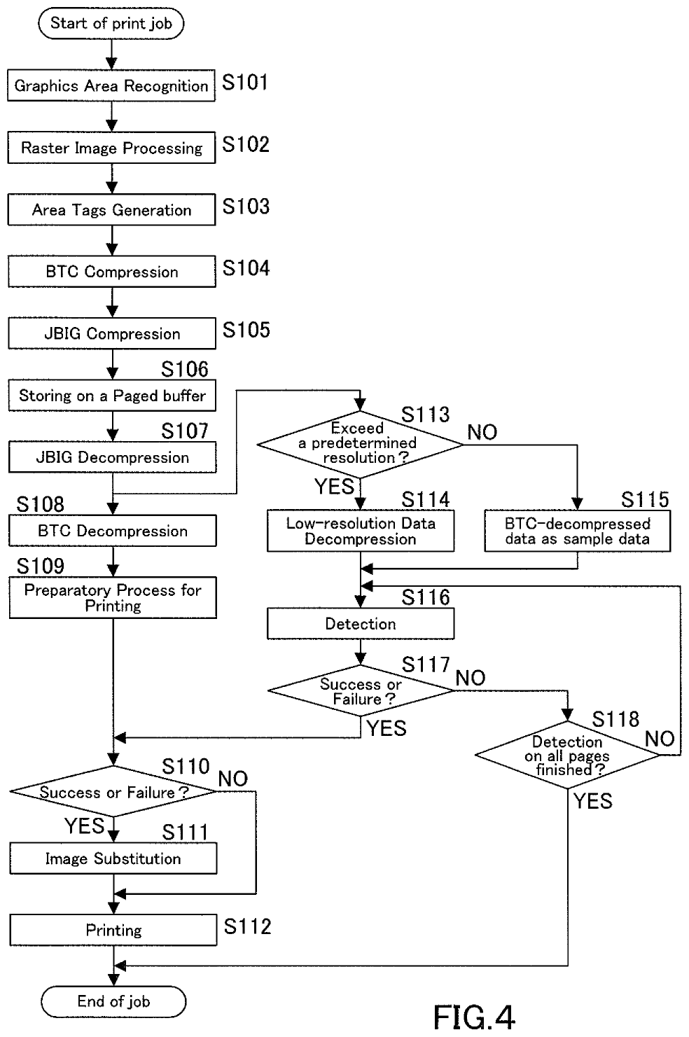

FIG. 4 is a flowchart representing a procedure to be performed on print data during a print job by the image processing apparatus 1 in the embodiment of FIGS. 2 and 3. The flowchart is executed by the CPU 101 of the image processing apparatus 1 in accordance with an operation program stored on a recording medium such as the ROM 102.

Upon the start of a print job, graphics area recognition is performed on print data in Step S101. Raster image processing is performed in Step S102, and area tags, which indicate a boundary between the graphics area and the non-graphics area, are generated in Step S103.

In Step S104, BTC compression is performed; if necessary, JBIG compression is further performed for less burden. After compression, it is stored on a paged buffer (paged memory) in Step S106.

When a need for decompression arises, JBIG decompression is performed in Step S107. After JBIG decompression, the flowchart has a branch point to continue to Step S108 for the course of printing or to Step S113 for the course of sample data generation and particular image detection.

In the course of printing, BTC decompression is performed in Step S108 and a preparatory process for printing, such as binarization, is performed in Step S109. In Step S110, particular image detection is performed and success or failure of detection is judged. If it is success of detection (YES in Step S110), other image data is substituted for the print data in Step S111. In Step S112, the substitute image data is printed out by a print engine, the imaging device 140, which is an ending of the print job. If it is not success of detection (NO in Step S110), the print data is immediately printed out by the print engine in Step S112, and this is an ending of the print job.

In the course of sample data generation, it is judged in Step S113 whether or not the resolution of print data is higher than a predetermined resolution for sample data. If it is higher than the predetermined resolution (YES in Step S113), decompression is performed using low-resolution data, the data D21 and D22 from the compressed data D2, in Step S114. The flowchart then proceeds to Step S116. If the print data is equal to or lower than the predetermined resolution (NO in Step S113), the print data decompressed by BTC techniques is defined as sample data in Step S115. The flowchart then proceeds to Step S116. Since sample data herein is exactly the print data having just been decompressed, there is no burden due to the process of generating sample data for the detection process.

In Step S116, particular image detection is performed using the sample data; and success or failure of detection is judged in Step S117. If it is success of detection (YES in Step S117), the flowchart proceeds to Step S110. If it is not success of detection (NO in Step S117), the flowchart proceeds to Step S118, in which particular image detection has been performed on all pages. If it has not been performed yet on all pages (NO in Step S118), the flowchart returns to Step S116, in which it is performed on a next page. If it has been performed on all pages (YES in Step S118), the flowchart terminates.

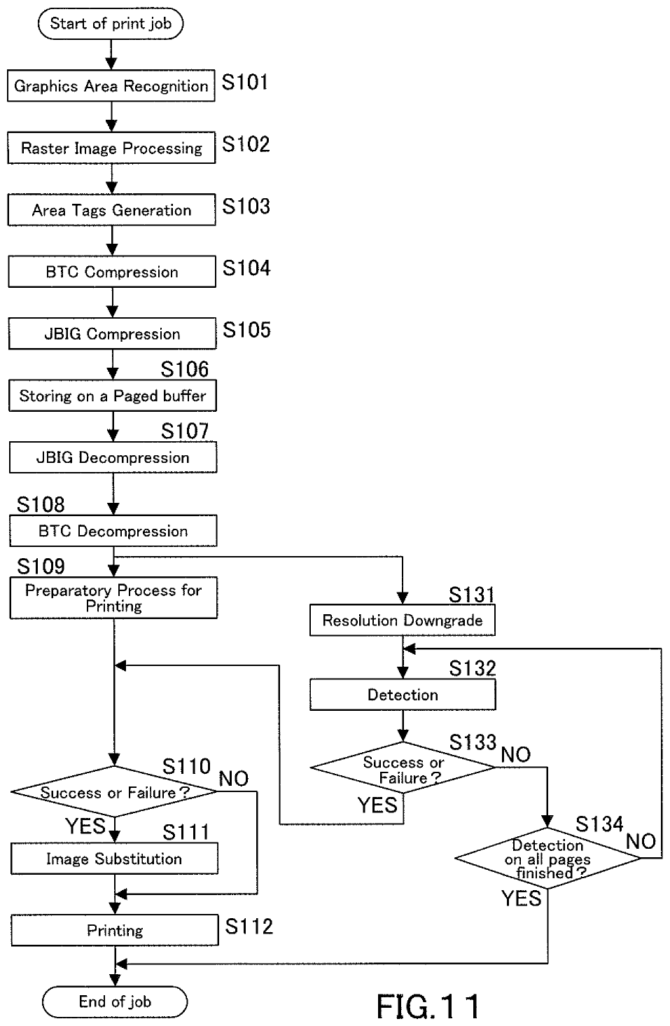

For reference, a conventional procedure to be performed during a print job by the image processing apparatus 1 in the embodiment of FIGS. 9 and 10 will be further described with reference to FIG. 11. The conventional procedure in FIG. 11 includes some steps (Steps S101 to S112) in common with FIG. 4. While these steps are given the same numbers as in FIG. 4, the description of these steps will be omitted.

In the course of particular image detection, resolution downgrade is performed on the decompression data after JBIG decompression and BTC decompression (Step S131) and sample data is thereby generated. The detection process is performed using the sample data (Step S132) and success or failure of detection is judged (Step S133). If it is success of detection (YES in Step S133), the flowchart proceeds to Step S110. If it is not success of detection (NO in Step S133), the flowchart proceeds to Step S134, in which particular image detection has been performed on all pages.

As described above, the conventional procedure causes the increase of the burden due to the process of generating sample data for the detection process because resolution downgrade (Step S131) is performed using the original print data retrieved by decompression.

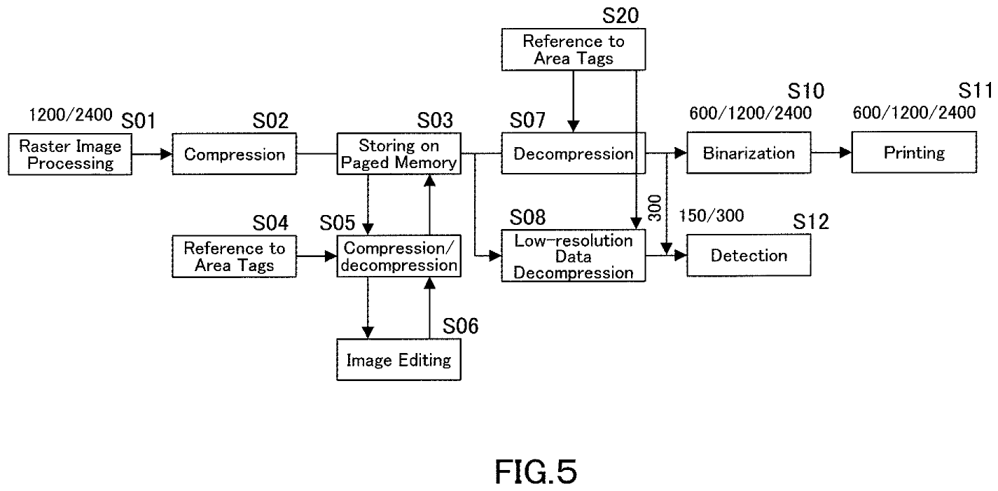

FIG. 5, similar to FIG. 2, is a flowchart representing a procedure to be performed on print data during a print job, including the process of generating sample data and the detection process, according to another embodiment of the present invention.

In this embodiment, sample data generation is performed with reference to area tags mentioned above.

The flowchart of FIG. 5 includes the following processes in common with FIG. 2: raster image processing (S01); compression by the compressor-decompressor 190 (S02); storing on the paged memory 103 (S03); area tag detection (S04); compression or decompression (S05); image editing (S06); decompression for printing (S07); binarization (S10); and printing (S11). These processes are given the same codes as in FIG. 2.

In this embodiment, low-resolution data decompression (S08) is performed with reference to area tags (S20). As for the graphics area defined by the area tags, low-resolution data decompression is performed and sample data with a resolution of 150 or 300 dpi is thereby obtained. The detection process (S12) is performed using the sample data, as in the embodiment of FIGS. 2 and 3.

The non-graphics area has no influence on the detection process because images plotted with points, lines, Bezier curves, and the like does not constitute forgery. So, as for the non-graphics area, the compressed data or decompressed data, whichever may be used in the detection process; low-resolution data decompression may be performed before the detection process, accordingly. Alternatively, the flowchart may omit the detection process.

There is a possibility that area tags go missing by compression after image editing. In this case, low-resolution data decompression is performed without area tags. That is, sample data generation is performed by entirely decompressing low-resolution pieces of data regardless of graphics or non-graphics area.

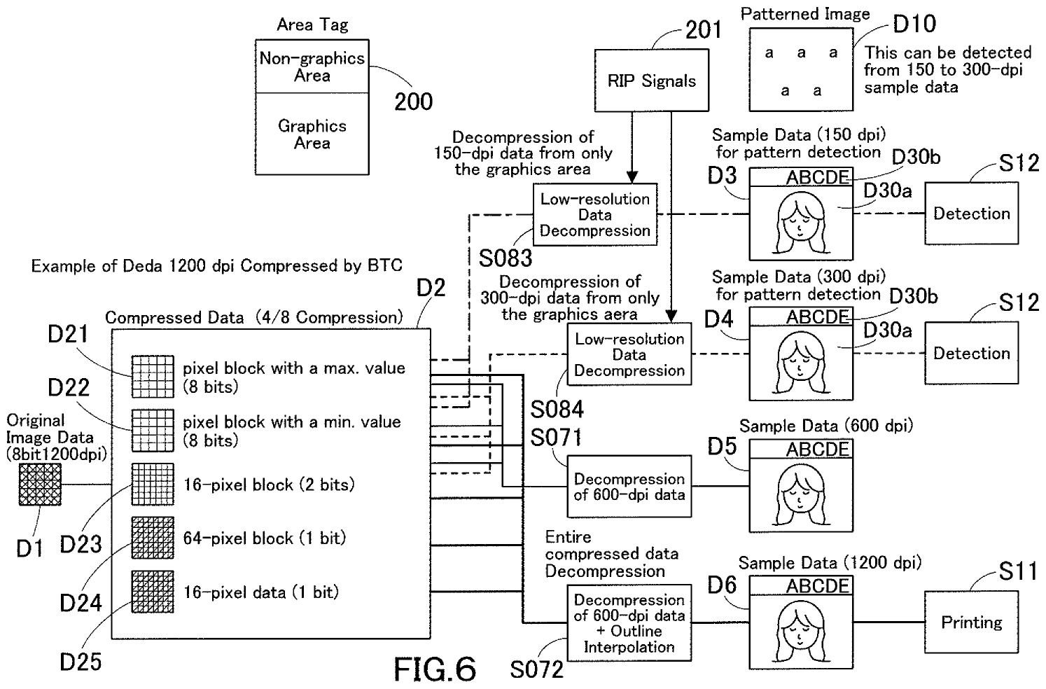

FIG. 6 is for reference in describing in detail how print data is processed during a print job in the embodiment of FIG. 5. FIG. 6 corresponds to FIG. 3.

FIG. 6 includes the following items and processes in common with FIG. 3: the original print data D1; the compressed data D2; the particular image D10; decompression S071 for the sample image data D6, whose resolution is 1200 dpi; decompression S072 for the sample image data D5, whose resolution is 600 dpi; and printing S11. The description of these items and processes will be omitted.

In this embodiment, area tags 200 are generated during raster image processing, and sample data generation is performed with reference to the area tags 200.

The area tags 200 correspond to RIP signals 201. Specifically, as indicated by chain lines in FIG. 6, while the compressed data D2 is composed of the five pieces of data D21 to D25, the data D21 (150 dpi, approximately) and the data D22 (150 dpi, approximately) are used for generation of the sample image data D3, whose resolution is 150 dpi. Low-resolution data decompression is performed (S083). Furthermore, as indicated by dashed lines in FIG. 6, the data D21 (150 dpi, approximately), the data D22 (150 dpi, approximately), and the data D23 (600 dpi, approximately) are used for generation of the sample image data D4, whose resolution is 300 dpi. Low-resolution data decompression is performed (S084).

In this embodiment, the RIP signals 201 stop the output of data from the non-graphics area in the process of decompressing low-resolution data (S083 and S084), allowing the removal of the non-graphics area which have no influence on the detection process. The original print data D1 has a color chart with the text “ABCDE” in the upper region D30b, and the color chart is created by computer graphics (CG) techniques. According to the area tag 200, the color chart is the non-graphics area. In low-resolution data decompression (S083 and S084), the output of data from the color chart with the text “ABCDE” is stopped, resulting in the upper region D30b being blank. The detection process is performed using the sample image data D3 and D4 excluding the blank region (S12), which would lighten the burden due to the detection process, shorten the processing time, and reduce the risk of error in detection.

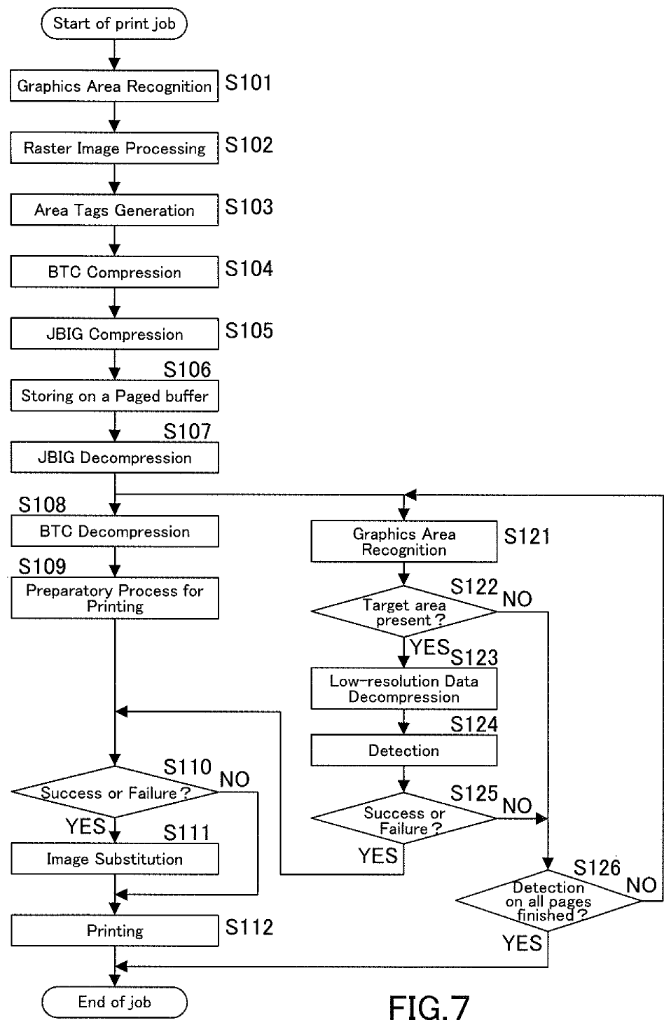

FIG. 7 is a flowchart representing a procedure to be performed on print data during a print job by the image processing apparatus in the embodiment of FIGS. 5 and 6. The flowchart is executed by the CPU 101 of the image processing apparatus 1 in accordance with an operation program stored on a recording medium such as the ROM 102.

The procedure in FIG. 7 includes some steps (Steps S101 to S112) in common with FIG. 4. While these steps are given the same numbers as in FIG. 4, the description of these steps will be omitted. The description will start with the step of detecting a particular image.

As in FIG. 4, sample data generation is performed using the decompressed data obtained by JBIG decompression, Step S107.

In Step S121, graphics area recognition is performed on the sample data with reference to the area tags 200. In Step S122, it is judged whether or not there is a graphics area. If there is a graphics area (YES in Step S122), low-resolution data decompression is performed on the graphics area in Step S123, and sample data is thereby obtained.

In Step S124, particular image detection is performed using the sample data; and success or failure of detection is judged in Step S125. If it is success of detection (YES in Step S125), the flowchart proceeds to Step S110.

If it is not success of detection (NO in Step S125), the flowchart proceeds to Step S126. Back to Step S122, if there is no graphics area (NO in Step S122), the flowchart proceeds to Step S126 as well.

In Step S126, particular image detection has been performed on all pages. If it has not been performed yet on all pages (NO in Step S126), the flowchart returns to Step S121. If it has been performed on all pages (YES in Step S118), the flowchart terminates.

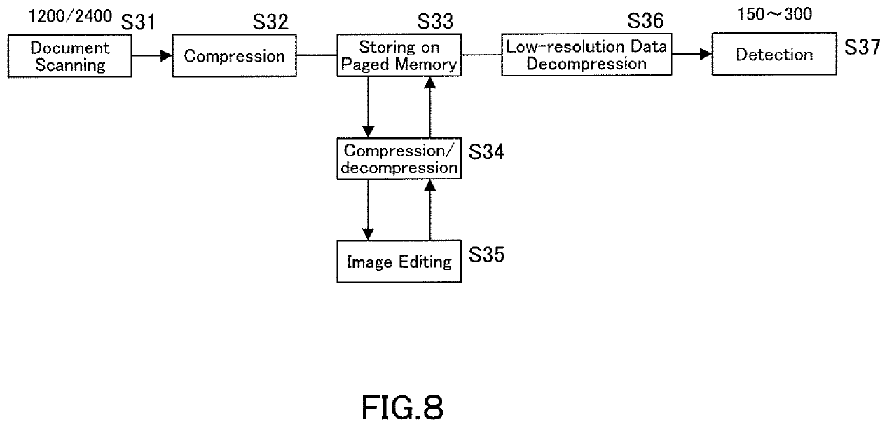

FIG. 8 is a flowchart representing a procedure to be performed on scanned data, according to yet another embodiment of the present invention.

In this embodiment, target data for printing is not print data externally received but scanned data obtained by document scanning by the image reading device 120.

Document scanning is performed (S31) and scanned data is thereby obtained. Compression is performed on the scanned data as it is done on print data (S32), and the compressed data is temporarily stored on the paged memory 103 (S33). When a need for image editing arises, the compressed data stored thereon is decompressed by the compressor-decompressor 190, and image editing is then performed (S35).

After image editing, in the course of detecting a particular image such as a paper currency image from the scanned data, it is compressed again (S34) and stored on the paged memory 103 (S33). The compressed data stored thereon has the same composition as the compressed data D2 illustrated in FIGS. 3 and 6. Low-resolution data decompression is performed on the sample data D21 and D22 included in the compressed data D2 (S36), and sample data with a resolution of 150 or 300 dpi is thereby obtained. The decompression method used here in low-resolution data decompression is the same as that described above with reference to FIG. 3.

Using the sample data thus obtained, particular image detection is performed (S37).

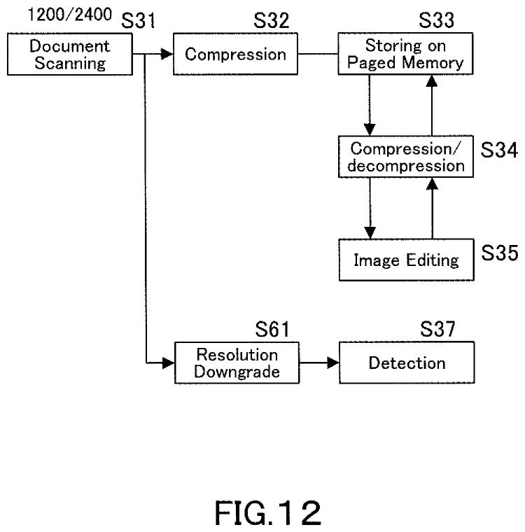

FIG. 12 illustrates a conventional method of generating sample data from scanned data. FIG. 12 includes the following processes in common with FIG. 8: document scanning (S31); compression (S32); storing on the paged memory 103 (S33); compression or decompression (S34); image editing (S35); and a detection process (S37). These processes are given the same codes as in FIG. 8.

In the conventional procedure, resolution downgrade is performed on the scanned data (S61) before detection (S37). This process, downgrading the resolution of scanned data, causes a large burden.

In contrast, in the present embodiment, the compressed data is composed of some pieces of data. When a need for image editing arises, resolution downgrade is performed on only low-resolution pieces of data, and sample data is thereby obtained. It is not necessary any more to downgrade the resolution of the scanned data as in the conventional procedure. This would lighten the burden due to the process of generating sample data for the detection process.

While some embodiments of the present invention have been described in details herein it should be understood that the present invention is not limited to the foregoing embodiments. For example, the target data for printing may be printed out by an external apparatus instead of the image processing apparatus 1.

Although one or more embodiments of the present invention have been described and illustrated in detail, the disclosed embodiments are made for purposes of illustration and example only and not limitation. The scope of the present invention should be interpreted by terms of the appended claims

What is claimed is:

1. An image processing apparatus comprising a processor that performs:
compressing target data for printing;
decompressing the compressed target data; and
when the resolution of the uncompressed target data is higher than the resolution of low-resolution data included in the compressed target data, generating sample data by decompressing only the low-resolution data, the sample data to be used for a process of detecting data of a particular image from the target data.

2. The image processing apparatus according to claim 1, wherein the resolution of the low-resolution data is equal to or lower than a resolution predetermined for the sample data.

3. The image processing apparatus according to claim 1, wherein the target data is print data inputted from an external apparatus.

4. The image processing apparatus according to claim 3,
wherein raster image processing is performed on the print data and area tags are generated during the raster image processing, the area tags indicating a boundary between a graphics area and a non-graphics area, and
wherein the processor generates the sample data with reference to the area tags.

5. The image processing apparatus according to claim 4, wherein the processor generates the sample data by decompressing only the graphics area, the graphics area being defined by the area tags.

6. The image processing apparatus according to claim 4, wherein, when the area tags go missing and the resolution of the uncompressed target data is higher than the resolution predetermined for the sample data, the processor generates the sample data by decompressing the low-resolution data entirely regardless of the graphics or non-graphics area.

7. The image processing apparatus according to claim 4, wherein, when the area tags go missing and the resolution of the uncompressed target data is equal to or lower than the resolution predetermined for the sample data, the processor generates the sample data by decompressing the compressed data entirely.

8. The image processing apparatus according to claim 1, wherein the target data is scanned data obtained by document scanning by a scanning device.

9. A non-transitory computer-readable recording medium storing a program for a computer of an image processing apparatus to execute:
compressing target data for printing;
decompressing the compressed target data; and
when the resolution of the uncompressed target data is higher than the resolution of low-resolution data included in the compressed target data, generating sample data by decompressing only the low-resolution data, the sample data to be used for a process of detecting data of a particular image from the target data.

10. The non-transitory computer-readable recording medium according to claim 9, wherein the resolution of the low-resolution data is equal to or lower than a resolution predetermined for the sample data.

11. The non-transitory computer-readable recording medium according to claim 9, wherein the target data is print data inputted from an external apparatus.

12. The non-transitory computer-readable recording medium according to claim 11,
wherein raster image processing is performed on the print data and area tags are generated during the raster image processing, the area tags indicating a boundary between a graphics area and a non-graphics area, and
wherein the program makes the computer generate the sample data with reference to the area tags.

13. The non-transitory computer-readable recording medium according to claim 12, wherein the program makes the computer generate the sample data by decompressing only the graphics area, the graphics area being defined by the area tags.

14. The non-transitory computer-readable recording medium according to claim 12, wherein, when the area tags go missing and the resolution of the uncompressed target data is higher than the resolution predetermined for the sample data, the program makes the computer generate the sample data by decompressing the low-resolution data entirely regardless of the graphics or non-graphics area.

15. The non-transitory computer-readable recording medium according to claim 12, wherein, when the area tags go missing and the resolution of the uncompressed target data is equal to or lower than the resolution predetermined for the sample data, the program makes the computer generate the sample data by decompressing the compressed data entirely.

16. An image forming apparatus comprising the non-transitory computer-readable recording medium according to claim 9, wherein the target data is scanned data obtained by document scanning by a scanning device, the image forming apparatus comprising:
a fusing device having: a pad member; and a pressure member that works to form a nip region in the interface with the pad member;
a contact condition changing mechanism that optimizes the distribution of interfacial pressure in the nip region by changing the contact condition between the pad member and the pressure member, and that changes the contact condition between the pad member and the pressure member by moving either or both of the pad member and the pressure member;
an image information sensor that senses image information from a sheet of paper having passed through the nip region; and
a processor that makes the contact condition changing mechanism optimize the distribution of interfacial pressure in the nip region with reference to a sensing result obtained by the image information sensor.
